(19) United States
(12) Patent Application Publication
(10) Pub. No.: US 2023/0016557 A1
(43) Pub. Date: Jan. 19, 2023

(54) SAFETY DEVICE FOR A COUNTERSINK TOOL

(71) Applicant: AGCO International GmbH, Neuhausen (CH)

(72) Inventors: Xaver Oberbauer, Marktoberdorf (DE); Stefan Cyrus, Marktoberdorf (DE); Stefan Preschl, Marktoberdorf (DE)

(21) Appl. No.: 17/812,076

(22) Filed: Jul. 12, 2022

(30) Foreign Application Priority Data
Jul. 14, 2021 (GB) 2110115.9

(51) Int. Cl. B23B 51/10

(52) U.S. Cl. CPC B23B 51/104; B23B 51/101; B23B 2231/0232; B23B 2260/12

(57) ABSTRACT

A deburring mechanism with a rotatable countersink, a cylindrical shaft, a conical cutting contour and a cylindrical cutting edge configured to mount to a driven workstation shaft so that when a workpiece comes in contact with the cutting edge, burrs are removed from the workpiece. The deburring mechanism has a safety device attached to the shaft and adjacent the countersink. The safety device has a rotationally symmetric body with openings through which removed burrs move, a circular outer guard, a mounting portion with legs and a hexagonal mounting contour corresponding with an interior bore of the driven shaft and configured such that a driving connection of the countersink only occurs when the safety device is assembled and overlaps the transition area with a protective contour.

### BACKGROUND OF THE INVENTION

### Field of Invention

The invention relates to safety device for a countersink tool.

### Description of Related Art

Countersink tool are generally used to deburr bores in formed workpieces after drilling or other manufacturing steps. One problem with using such countersink tools is that the cutting edge of the tool may injure a worker. Especially when wearing gloves, a glove may be caught by the countersink tool causing the hand of the worker to be forced towards the cutting edges resulting in serious accidents. Therefore, it is often prohibited by accident prevention regulations to wear gloves when the worker's hand may come in close proximity with the countersink tool. On the other hand, especially in sheet metal production, laser cutting of the workpiece leaves sharp edges that can cut the worker's hand when handling the workpiece. Furthermore, some production steps require process materials such as cooling lubricants that can negatively affect the human skin or cause allergic reactions.

FIGS. 1A and 1B show a known design of a manufacturing apparatus 10 comprising a deburring machine 12 which can be moved manually in direction indicated with arrow X towards a workpiece 18 made of steel. A countersink 20 is drivingly connected to a driven shaft 16 of the deburring machine 12 for rotation R to deburr a bore 15 which was provided in a previous drilling step which left burrs B at the edges of the bore 18. Countersink 20 is therefore provided with at least one conical cutting edge 20a which extends into a further cylindrical cutting edge 20b. A burr channel 20c is formed to enable the burrs to be transported away from the workpiece 18. To prevent the countersink 20 from moving too deep into the workpiece 18 during operation as depicted in FIG. 1B, a depth stop 30 is provided. The depth stop 30 is clamped to the countersink 20 by two grub screws 32 for fixing relative position of the depth stop 20 on the countersink 20. To enable the burrs B that are cut off from workpiece 18 to be properly transported away from the workpiece 18, the depth stop 30 is also provided with a burr opening 34. The depth stop 30 is connected directly to the shaft of the countersink 20, which is driven by a machine drive.

FIGS. 2A and 2B depicts a further known design of a safety device 40 for use in a similar deburring machine 12. The safety device 40 comprise a rotationally symmetric body 42 including a cylindrical recess 44. In the inoperative position shown in FIG. 2A, the safety device 40 is forced downwards by gravity to cover the cutting contour 20a and cylindrical cutting edge 20b of countersink 20 to prevent a hand of the worker from accessing the transition area 20d between cutting contour 20a and cylindrical cutting edge 20b. In this transition area 20d, it is possible that a glove of the worker could be caught by the countersink potentially causing significant injury.

When brought into its operative position as shown in FIG. 2B, the safety device 40 is forced upwards by the contact with work piece 18. The safety device is not provided with an opening to discharge loose burrs so these may get trapped in the cylindrical recess 44 and result in blockage. Such a safety device, also including a biasing spring to provide a downwards force on the safety device, is published as DE1020740U1.

The above-described devices are primarily used in a manufacturing apparatus where the countersink is movable towards a work piece resting on a machine base. This requires the worker to hold the workpiece and further move the countersink downwards after starting the rotation drive of the countersink, typically by operating an activation switch with one's hand or foot. This requires multiple handling steps and may be difficult when workpieces of large scale or complex geometry must be worked. Additionally, workpieces are difficult to handle as the edges are very sharp and may cut the hand of the workers. It therefore would be desirable to have an improved safety device for the countersink tool.

Overview of the Invention

In one embodiment, the invention is directed to a deburring mechanism having a rotatable countersink with a cylindrical shaft, a conical cutting contour and a cylindrical cutting edge configured to mount to a driven workstation shaft such that when a workpiece is comes in contact with the cutting contour and cutting edge of the countersink the countersink removes burrs from the workpiece. The deburring mechanism has a safety device attached to the cylindrical shaft and positioned adjacent the countersink so that a transition area located between the cutting contour and cylindrical cutting is covered by the safety device. The safety device has a rotationally symmetric body with a circular outer guard extending from a mounting portion with a plurality of legs, wherein the symmetric body is provided with openings between the legs through which burrs removed from the workpiece move through the body. The mounting portion is provided with a hexagonal mounting contour which corresponds with an interior bore of the driven shaft such that a driving connection of the countersink is only provided when the safety device is assembled. The safety device covers the transition area with a protective contour that corresponds to the shape of the transition area and extends over the transition area with an overlap.

These and other features and advantages of this invention are described in, or are apparent from, the following detailed description of various exemplary embodiments of the systems and methods according to this invention.

### BRIEF DESCRIPTION OF THE DRAWINGS

The above mentioned and other features of this invention will become more apparent and the invention itself will be better understood by reference to the following description of embodiments of the invention taken in conjunction with the accompanying drawings, wherein:

FIG. 1A illustrates a front view of a manufacturing apparatus comprising a depth stop for a countersink tool known in the art in a first, inoperative position;

FIG. 1B illustrates a front view of a manufacturing apparatus comprising a depth stop for a countersink tool known in the art in a second, operative position;

FIG. 2A illustrates a front view of a manufacturing apparatus comprising a safety device for a countersink tool in a first, inoperative position;

FIG. 2B illustrates a front view of a manufacturing apparatus comprising a safety device for a countersink tool in a second, operative position;

FIG. 3 illustrates a sectional view of an embodiment of a manufacturing apparatus comprising a safety device for a countersink tool;

FIG. 4A illustrate the safety device of FIG. 3 in bottom view;

FIG. 4B illustrate the safety device in front view;

FIG. 4C illustrate the safety device in perspective view seen from below;

FIG. 4D illustrate the safety device in section view A-A of FIG. 4C;

FIG. 5 illustrates the safety device in section view A-A of FIG. 3; and

FIG. 6 illustrates an enlarged sectional view of the safety device and countersink tool of FIG. 3.

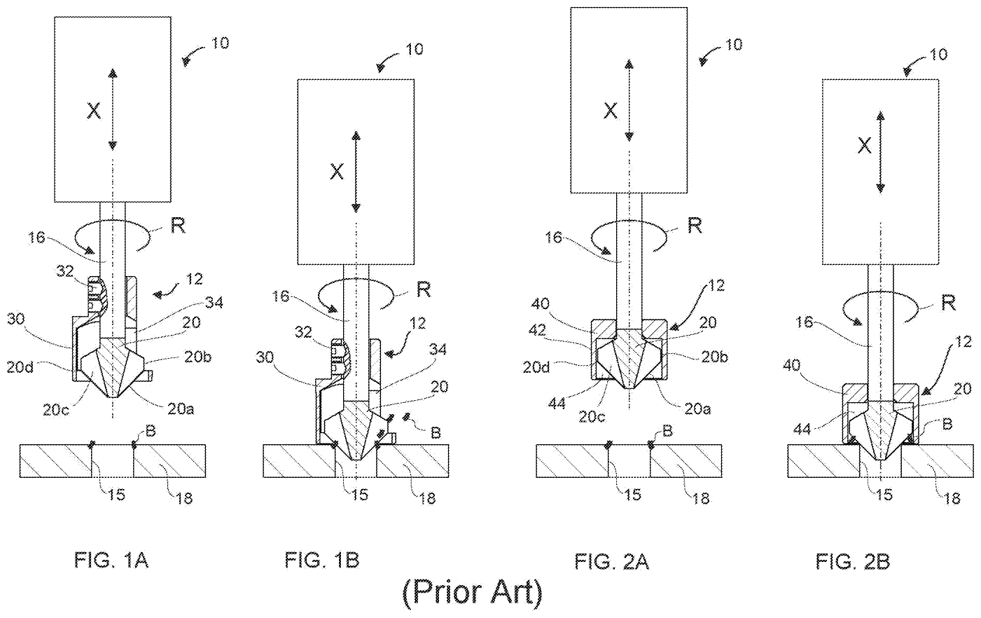

Corresponding reference characters indicate corresponding parts throughout the views of the drawings.

### DETAILED DESCRIPTION OF EXEMPLARY EMBODIMENTS

The invention will now be described in the following detailed description with reference to the drawings, wherein preferred embodiments are described in detail to enable practice of the invention. Although the invention is described with reference to these specific preferred embodiments, it will be understood that the invention is not limited to these preferred embodiments. But to the contrary, the invention includes numerous alternatives, modifications and equivalents as will become apparent from consideration of the following detailed description.

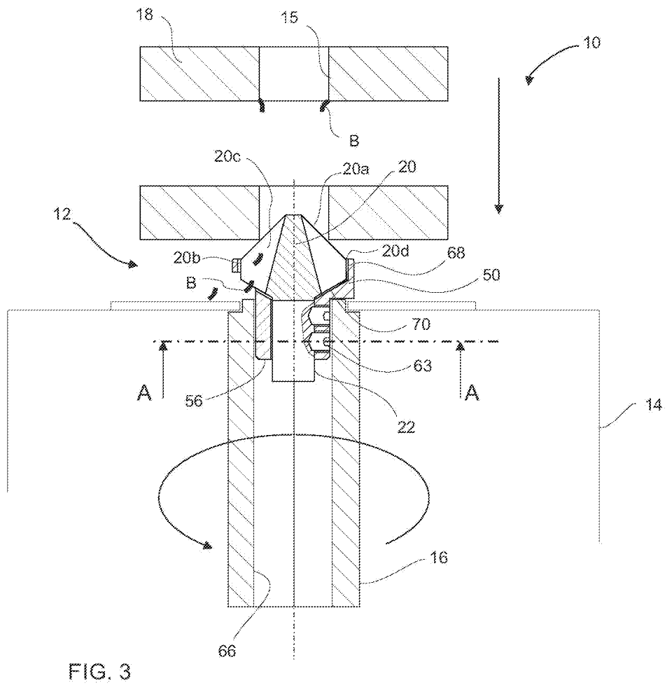

Turning now to FIG. 3, a manufacturing apparatus 10 having a deburring mechanism 12 in which a rotatable countersink 20 is assembled to a workstation 14. The countersink 20 has a conical cutting contour 20A and a cylindrical cutting edge 20B. In the illustrated embodiment, the countersink 20 has a cylindrical shaft 22 and the position of the deburring mechanism 12 is fixed relative the workstation 14 to a driven workstation shaft 16, and a workpiece 18 is moved towards the cutting contour 20A and cutting edge 20B of the countersink 20. This embodiment is especially advantageous if the deburring process is done where the workstation 14 uses a cutting/forming machine (not shown) with a laser cutting process to manufacture the workpiece 18, such as a plane cut blank, or with a forming process, such as when the blank is formed by a pressing or edging machine. As would be understood, a worker takes the workpiece 18 out of the initial cutting/forming machine and then performs the deburring process while the next workpiece is moved to the cutting/forming machine.

As understood, workpieces 18 are difficult to handle as edges of the workpiece 18 can be very sharp and may cut the hand of the worker handling the workpiece 18. To enable the worker to wear gloves, the deburring mechanism 12 has a safety device 50 is positioned adjacent the cutting edges 20A, 20B of the countersink 20 to discourage the glove from getting caught up by the countersink 20. The safety device 50 is positioned so that a transition area 20d between the conical cutting contour 20a and cylindrical cutting 20b is covered.

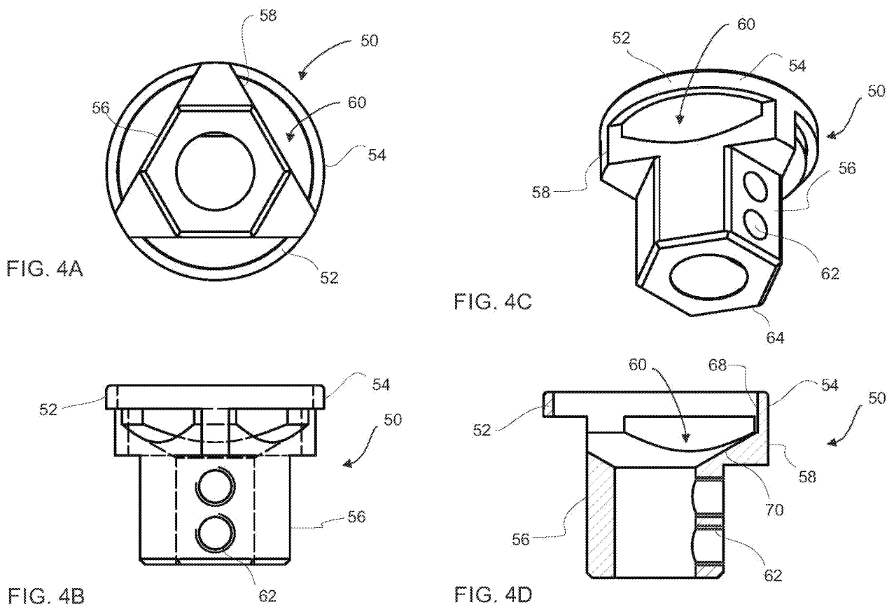

With reference also now to FIGS. 4A-4D, the safety device 50 has a rotationally symmetric body 52 having a circular outer guard 54 connected to a mounting portion 56 with a plurality of legs 58. In the illustrated embodiment, there are three legs 58 that mate with the mounting portion 56 such that the mounting portion 56 has a hexagonal shape. As the removed burrs B would be trapped in the safety device 50, the rotationally symmetric body 52 is provided with openings 60 between the legs 58 through which burrs B can fall downwards to avoid blockage.

With reference to FIG. 4D the safety device 50 is provided with bores 62 for screw connection with the cylindrical shaft 22 of the countersink 20. In the illustrated embodiment, the safety device 50 is fixed to the countersink 20 via two grub screws 63 positioned in the bores 62.

To avoid that the countersink 20 being used without the safety device 50 being attached, the manufacturing apparatus 10 requires that the drive shaft 16 mate with the deburring mechanism 12. The mounting portion 56 of the safety device 50 is provided with a hexagonal mounting contour 64 which corresponds with the shape of an interior bore 66 of the driven shaft 16. Thereby, driving connection of the countersink 20 can only be provided when the safety device 50 is properly assembled as the rotational drive can only be provided via the hexagonal contour 64 provided in the safety device 50. If the safety device 50 is not installed, shaft 22 of the countersink 20 cannot mate with the driven shaft 16 and the connection to the drive shaft 16 is disabled. Desirably, even if one were to use a countersinks with a hexagonal shaft, the size of the shaft would not fit with the driven shaft 16. In the illustrated embodiment, the mounting contour 64 has a hexagonal shape, but may alternatively be of triangular, rectangular or any other suitable shape to prohibit driving connection of the countersink 20 without the safety device 50 assembled.

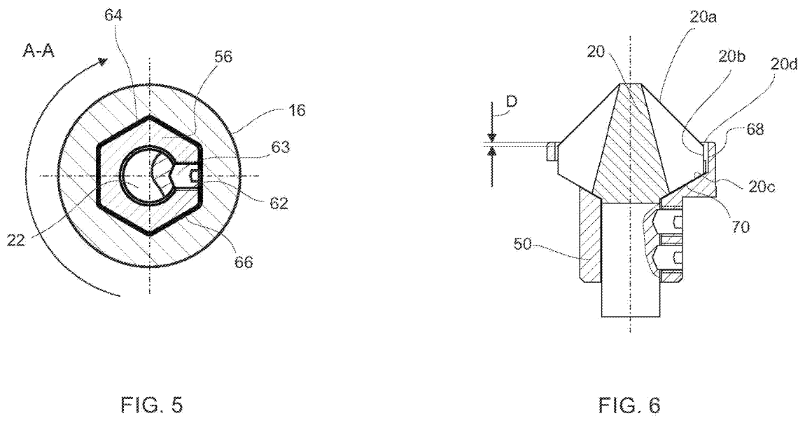

As perhaps seen in the section view of FIG. 5, while the safety device 50 is connected to the countersink 20 via grub screws, the deburring mechanism 12 is connected to the driven machine shaft 18 of the workstation 14 only via the hexagonal contour 62 such that no screws are used to connect the deburring mechanism 12 to the driven shaft 16. The assembly of the deburring mechanism 12 on the workstation 14 is maintained by gravity and therefore can be easily exchanged.

As best seen in FIGS. 3 and 6, the position and shape of the safety device 50 is defined to ensure that the transition area 20D between cutting contour 20A and cylindrical cutting edge 20B, which is area that a worker's gloves is most likely to be caught, is covered by an upper edge of the safety device 50. The safety device 50 is provided with a protective contour 68 that corresponds to the shape of the transition area 20D between the conical cutting contour 20A and the cylindrical cutting edge 20b and extends over transition area 20D with an overlap indicated by reference D in FIG. 6. Furthermore, a stop contour 70 is provided that corresponds to a rearward shape 20C of the countersink 20 to ensure that the relative position between safety device 50 and countersink 20 can be easily adjusted just by inserting the countersink 20 into the safety device 50 until stop contour 70 and rearward shape 20C come into contact. This enables simple, easy and safe exchange of the countersink 20. In the illustrated embodiment, the stop contour 70 has a conical portion, but may alternatively be planer or other shape, depending the rearward shape 20C of the countersink 20.

The foregoing has broadly outlined some of the more pertinent aspects and features of the present invention. These should be construed to be merely illustrative of some of the more prominent features and applications of the invention. Other beneficial results can be obtained by applying the disclosed information in a different manner or by modifying the disclosed embodiments. Accordingly, other aspects and a more comprehensive understanding of the invention may be obtained by referring to the detailed description of the exemplary embodiments taken in conjunction with the accompanying drawings.

1. A deburring mechanism comprising a rotatable countersink with a shaft, a conical cutting contour and a cylindrical cutting edge configured to mount to a driven workstation shaft such that when a workpiece comes in contact with the cutting contour and cutting edge of the countersink the countersink removes burrs from the workpiece, the deburring mechanism comprising:
a safety device attached to the shaft and positioned adjacent the countersink so that a transition area located between the cutting contour and cylindrical cutting edge is covered by the safety device, the safety device comprising:
a rotationally symmetric body with a circular outer guard extending from a mounting portion with a plurality of legs, wherein the symmetric body comprises:
openings between the legs through which burrs removed from the workpiece move through the body,
wherein the safety device covers the transition area with a protective contour that corresponds to the shape of the transition area and extends over the transition area with an overlap.

2. The deburring mechanism of claim 1, wherein the safety device has three legs extending from the mounting portion such that the mounting portion forms a hexagonal shape.

3. The deburring mechanism of claim 1, wherein the mounting portion comprises a hexagonal mounting contour which corresponds with an interior bore of the driven shaft such that a driving connection of the countersink only occurs when the safety device is assembled.

4. The deburring mechanism of claim 1, wherein the safety device is fixed to the cylindrical shaft of the countersink with screws positioned in bores in the mounting portion of the body.

5. The deburring mechanism of claim 1, wherein the deburring mechanism is connectable to a driven shaft only via the hexagonal contour such that no fasteners are used to connect the deburring mechanism to the driven shaft.

6. The deburring mechanism of claim 1, wherein a the body has a stop contour that corresponds to a rearward shape of the countersink to ensure that the relative position between the safety device and the countersink is adjusted by inserting the countersink into the safety device until the stop contour and rearward shape come into contact.
